(19) United States
(12) Patent Application Publication
(10) Pub. No.: US 2026/0060357 A1
(43) Pub. Date: Mar. 5, 2026

(54) HELMET WITH SKELETAL SUPPORT STRUCTURE

(71) Applicant: James Wood, Shoreline, WA (US)

(72) Inventor: James Wood, Shoreline, WA (US)

(21) Appl. No.: 18/817,815

(22) Filed: Aug. 28, 2024

(51) Int. Cl. A42B 3/06; A42B 3/12; A42B 3/28

(52) U.S. Cl. CPC A42B 3/063; A42B 3/065; A42B 3/125; A42B 3/283; B29C 44/3453

(57) ABSTRACT

A helmet is disclosed, including a polycarbonate skeletal shell having a plurality of voids. The polycarbonate skeletal shell includes an inner surface and an outer surface. A closed-cell foam layer is molded over at least the outer surface of the polycarbonate skeletal shell. A protective layer is molded over the closed-cell foam layer and a plurality of foam pads attached to at least the inner surface of the polycarbonate skeletal shell.

### TECHNICAL FIELD

The embodiments disclosed herein generally relate to protective equipment, and more specifically to helmets having a skeletal support structure.

### BACKGROUND

Protective equipment is often worn during high-risk activities to protect individuals from injury. In particular, helmets are a form of protective gear which are worn to protect the head and central nervous system of the wearer. Their use is common in recreational activities and sports such as racing, American football, ice hockey, baseball, skiing, among others. Helmets are also commonly used while performing dangerous work activities such as construction, mining, police, military, and in transportation (e.g., motorcycle helmets).

Helmets are commonly constructed of various types of plastics and resins which provide a lightweight construction. The interior of the helmet can include padding which provides comfort to the wearer and increases the ability of the helmet to absorb shock caused by an impact events. The exterior of most helmets is formed of a hard exterior shell. Although effective, the hard exterior shell of many helmets has been known to cause injury to others. This is especially prevalent in American football, where impact of the hard exterior shell to unprotected body parts of another player can significantly increase their risk of injury.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a helmet, including a polycarbonate skeletal shell having a plurality of voids. The polycarbonate skeletal shell includes an inner surface and an outer surface. A closed-cell foam layer is molded over at least the outer surface of the polycarbonate skeletal shell. A protective layer is molded over the closed-cell foam layer and a plurality of foam pads attached to at least the inner surface of the polycarbonate skeletal shell.

To manufacture the helmet, the polycarbonate layer is formed having the plurality of voids and includes the inner surface and outer surface. The closed-cell foam layer is then molded over the outer surface of the polycarbonate skeletal shell. A protective layer is then molded over the closed-cell foam layer. A plurality of foam pads are then attached to the inner surface of the polycarbonate skeletal shell.

In one aspect, reaction molding is used to mold the closed-cell foam layer over at least the outer surface of the polycarbonate skeletal shell.

The advantage over the existing helmet technology is that the outer shell of the proposed helmet is soft. The helmets that are currently in production have a hard outer shell. The embodiments include a soft foam outer shell (such as one made with polyurethane or similar materials) that adds additional head protection along with additional protection to other body parts that are impacted by a soft helmet. Hard-shell helmets have caused injury to hands and other body parts. The present embodiments utilize a skeletal support frame rather than a solid helmet. The skeletal frame reduces the weight of the helmet without compromising the structural integrity of the helmet.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a front elevation view of the helmet, according to some embodiments;

FIG. 1 illustrates a side elevation view of the helmet, according to some embodiments;

FIG. 3 illustrates a top plan view of the helmet, according to some embodiments;

FIG. 4 illustrates a perspective view of the helmet, according to some embodiments; and

FIG. 5 illustrates a flowchart of a method for manufacturing the helmet, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a helmet which includes a polycarbonate skeletal shell which provides a soft exterior shell and skeletal support structure. The embodiments improve head and body protection for the user while performing high risk activities wherein impact to the head and/or face is common (e.g., while playing football). The exterior (i.e., the outer shell) may be constructed of polyurethane foam or a similar material capable of providing protection from impact with objects and/or other people. The foam may be supported by a skeletal frame that is injection molded. The inside of the helmet (i.e., the side which contacts the users head) is constructed of a foam material such as any foam material commonly used in the construction of helmets to form a padding. The exterior of the helmet may also include a vinyl skin. Ventilation holes are positioned through the helmet to enable the ingress and egress of air, thus aiding in cooling the users head while the helmet is being worn.

In some embodiments, the outer shell is constructed of between 0.5-1-inch thick closed-cell foam.

In some embodiments, the skeletal frame may be constructed of injection-molded Lexan, or a similar material.

In some embodiments, the inside of the helmet includes a foam padding to provide impact protection and also provide a comfortable interior surface which contacts the head of the user.

In some embodiments, the vinyl skin provides a thin, waterproof, flexible, and durable layer which provides an additional protective element to the helmet.

In some embodiments, the foam layer is constructed using closed-cell foam which provides a waterproof material which prevents moisture from getting inside the foam. Closed-cell foam provides a more rigid and durable material than other foams (e.g., open-cell foam).

To manufacture the helmet, the polycarbonate layer is formed having the plurality of voids and includes the inner surface and outer surface. The closed-cell foam layer is then molded over the outer surface of the polycarbonate skeletal shell. A protective layer is then molded over the closed-cell foam layer. A plurality of foam pads are then attached to the inner surface of the polycarbonate skeletal shell.

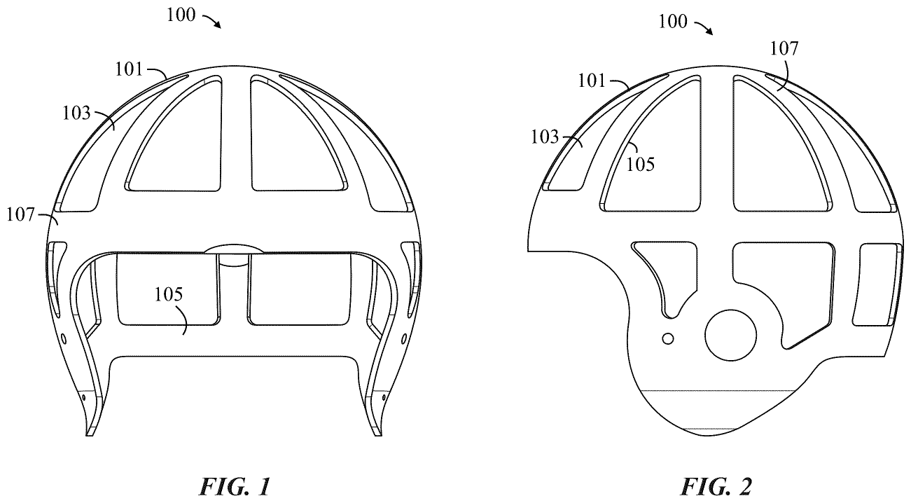

FIGS. 1-4 illustrate various views of the helmet 100 which is comprised of a skeletal shell 101 having a plurality of voids 103. The skeletal shell includes an inner surface 105 and an outer surface 107. A foam layer 109 is molded over at least the outer surface 107 of the skeletal shell 101. A protective layer 111 is molded over the foam layer 109 which forms the exterior 113 of the helmet 100. A plurality of foam pads 115 are attached to the inner surface 105 of the skeletal shell 101 such that the foam pads 115 contact the user's head while the helmet 100 is being worn.

In some embodiments, and in specific reference to FIG. 4, the foam layer 109 is constructed of closed-cell foam 119. A plurality of ventilation holes 121 are positioned through the foam layer 109 such that at least a portion of the ventilation holes 121 align with at least a portion of the plurality of voids 103 of the skeletal shell 101. The alignment of the ventilation holes 121 and the voids 103 allows for the ingress and egress of air through the helmet to provide ventilation, thus cooling the head of the user.

In some embodiments, the skeletal shell 101 is constructed of a polycarbonate material 117. The closed-cell foam layer 109 molded over the outer surface 107 provides a softer surface compared to the hard skeletal shell 101. In such, the closed-cell foam layer 109 reduces effects of impact (i.e., reduces the likelihood of causing an injury) imparted to another individual while the user is wearing the helmet 100.

In some embodiments, the protective layer 111 is constructed of a waterproof material to prevent degradation of the helmet components which may be caused by moisture. For example, the protective layer 111 may be constructed of vinyl or nylon.

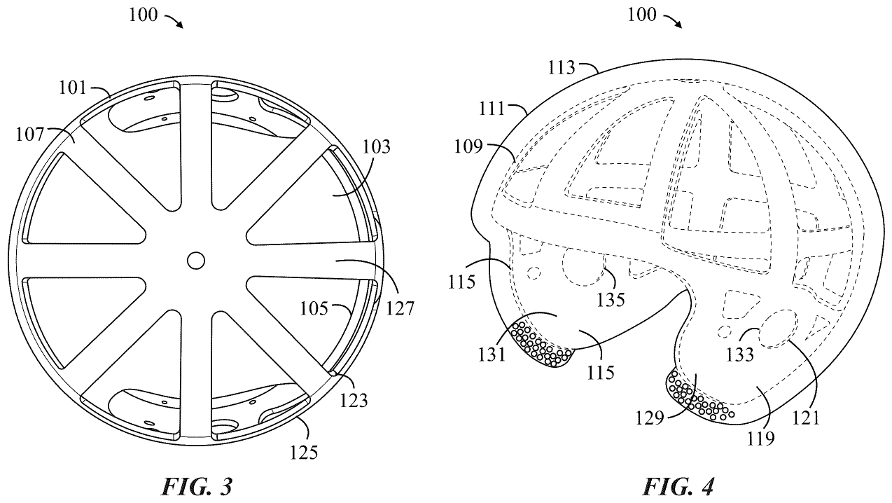

The skeletal shell 101 is comprised of a hemispherical portion 123 (see FIG. 3) which is dimensioned to fit over the head of the user. The hemispherical portion 123 may be form-fitting, such that the helmet is constructed to compliment the user's anatomy. At least one horizontal rib 125 is provided on the skeletal shell and a plurality of arced ribs 127 extend from the hemispherical portion 123 to the horizontal rib 125. Further, the skeletal shell 101 may include ear covers 129,131 which extend from the bottom portion 135 of the helmet 101. The ear covers 129,131 are designed to at least partially cover the ears of the user. Each ear cover 129,131 may include an aperture 133,135 which enhances the ability of the user to hear their surroundings, while enhancing ventilation. The apertures 133,135 are molded into the skeletal frame 101 and foam layer 109.

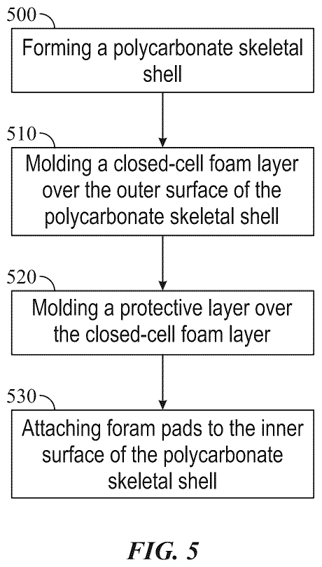

FIG. 5 illustrates a flowchart of a method for constructing the helmet. In step 500, a polycarbonate skeletal shell is formed which includes the plurality of voids, an inner surface, and an outer surface. In step 510, a foam layer is molded over at least the outer surface of the skeletal shell. In step 520, a protective layer is molded over the foam layer. In step 530, a plurality of foam pads are attached to at least the inner surface of the skeletal shell.

In some embodiments, the method described above includes the process of reaction injection molding (RIM) the foam layer over at least the outer surface of the polycarbonate skeletal shell.

Reaction injection molding (RIM) provides design flexibility by enabling the creation of shapes and components which may not be achievable using typical injection molding processes. The use of reaction injection molding can be beneficial for producing the thin structures of the helmet, thus reducing weight while maintaining strength.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A helmet, comprising:
a polycarbonate skeletal shell having a plurality of voids, the polycarbonate skeletal shell having an inner surface and an outer surface;
a closed-cell foam layer molded over at least the outer surface of the polycarbonate skeletal shell, wherein the closed-cell foam layer has a thickness in the range from approximately 0.5 inches to approximately 1 inch and is reaction injection molded;
a protective layer molded over the closed-cell foam layer, the protective layer being waterproof and made of at least one of vinyl or thermal-plastic polyurethane; and
a plurality of foam pads attached to at least the inner surface of the polycarbonate skeletal shell, wherein the foam pads are positioned to avoid covering the plurality of voids, allowing airflow through the aligned voids and foam layer ventilation hole.

2. The helmet of claim 1, wherein the polycarbonate skeletal shell is made primarily of at least one polycarbonate.

3. The helmet of claim 1, wherein the closed-cell foam layer has a plurality of ventilation holes, wherein at least a portion of the plurality of voids of the polycarbonate skeletal shell is aligned with a portion of the plurality of ventilation holes.

4. The helmet of claim 1, wherein the closed-cell foam layer molded over at least the outer surface of the polycarbonate skeletal shell is softer than the polycarbonate skeletal shell.

5. (canceled)

6. The helmet of claim 1, wherein the protective layer is waterproof.

7. The helmet of claim 1, wherein the polycarbonate skeletal shell includes:
a hemispherical portion;
at least one horizontal rib; and
a plurality of arced ribs extending from the hemispherical portion to the at least one horizontal rib.

8. The helmet of claim 1, wherein the protective layer is made primarily of vinyl or nylon.

9. A method of making a helmet, the method comprising the steps of:
forming a polycarbonate skeletal shell having a plurality of voids, the polycarbonate skeletal shell having an inner surface and an outer surface;
molding a closed-cell foam layer over at least the outer surface of the polycarbonate skeletal shell;
molding a protective layer over the closed-cell foam layer; and
attaching a plurality of foam pads to at least the inner surface of the polycarbonate skeletal shell.

10. The method of claim 9, wherein the molding the closed-cell foam layer over at least the outer surface of the polycarbonate skeletal shell includes the step of:
reaction injection molding the closed-cell foam layer over at least the outer surface of the polycarbonate skeletal shell.

11. The method of claim 10, wherein the closed-cell foam layer has a plurality of ventilation holes, wherein at least a portion of the plurality of voids of the polycarbonate skeletal shell is aligned with a portion of the plurality of ventilation holes.

12. The method of claim I1, wherein the closed-cell foam layer molded over at least the outer surface of the polycarbonate skeletal shell is softer than the polycarbonate skeletal shell.

13. A helmet, comprising:
a polycarbonate skeletal shell having a plurality of voids, the polycarbonate skeletal shell having an inner surface and an outer surface;
a closed-cell foam layer molded over at least the outer surface of the polycarbonate skeletal shell, wherein the closed-cell foam layer has a thickness in the range from approximately 0.5 inches to approximately 1 inch and is reaction injection molded;
a plurality of ventilation holes, wherein at least a portion of the plurality of voids of the polycarbonate skeletal shell is aligned with a portion of the plurality of ventilation holes;
a protective layer molded over the closed-cell foam layer, the protective layer being waterproof and made of vinyl; and
attaching a plurality of foam pads attached to at least the inner surface of the polycarbonate skeletal shell, wherein the foam pads are positioned to avoid covering the plurality of voids, allowing airflow through the aligned voids and foam layer ventilation hole.

14. The helmet of claim 13, wherein the polycarbonate skeletal shell includes:
a hemispherical portion;
at least one horizontal rib;
a plurality of arced ribs extending from the hemispherical portion to the at least one horizontal rib.

15. The helmet of claim 13, wherein the closed-cell foam layer molded over at least the outer surface of the polycarbonate skeletal shell is softer than the polycarbonate skeletal shell.
